(19) United States
(12) Patent Application Publication
(10) Pub. No.: US 2018/0203825 A1
(43) Pub. Date: Jul. 19, 2018

(54) ELECTRONIC APPARATUS, ELECTRONIC SYSTEM, METHOD OF CONTROLLING ELECTRONIC APPARATUS, AND COMPUTER-READABLE RECORDING MEDIUM

(71) Applicant: SEIKO EPSON CORPORATION, Tokyo (JP)

(72) Inventor: Makoto SHIGEMITSU, Sapporo-Shi (JP)

(73) Assignee: SEIKO EPSON CORPORATION, Tokyo (JP)

(21) Appl. No.: 15/868,543

(22) Filed: Jan. 11, 2018

(30) Foreign Application Priority Data
Jan. 16, 2017 (JP) 2017-005107

(51) Int. Cl. G06F 17/21; G06F 3/14

(52) U.S. Cl. CPC G06F 17/211; G06F 3/1407

(57) ABSTRACT

An electronic apparatus includes a communication section adapted to communicate with a display device, a display section, an acquisition section adapted to obtain an image file including image data and a header, and a control section adapted to transmit the image data included in the image file obtained by the acquisition section to the display device using the communication section, retrieve text data from the header of the image file to display the text data on the display section.

### CROSS-REFERENCE

The entire disclosure of Japanese Patent Application No. 2017-005107, filed Jan. 16, 2017 is expressly incorporated by reference herein.

### BACKGROUND

### 1. Technical Field

The present invention relates to an electronic apparatus, an electronic system, a method of controlling an electronic apparatus, and a computer-readable recording medium.

### 2. Related Art

In the past, it has been performed to transmit an image file from an electronic apparatus to a display device to make the display device display an image based on the image file (see, e.g., JP-A-2016-9023).

Incidentally, there is a need that in the case in which the image file includes other data than the image data, it is desired to transmit the image data to the display device to be displayed, and at the same time to display the data included in the image file by the electronic apparatus separately from the display device. However, depending on the specification of the electronic apparatus, in some cases, it is unachievable to transmit the image data to the display device to be displayed, and at the same time to display the data included in the image file.

### SUMMARY

An advantage of some aspects of the invention is to enhance the convenience when making a display device display an image.

An aspect of the invention is directed to an electronic apparatus including a communication section adapted to communicate with a display device, a display section, an acquisition section adapted to obtain an image file including image data and a header, and a control section adapted to transmit the image data included in the image file obtained by the acquisition section to the display device using the communication section, retrieve text data from the header of the image file to display the text data on the display section.

According to the aspect of the invention, it is possible to make the display device display the image based on the image data included in the image file, and make the display section of the electronic apparatus display the text data included in the image file. Therefore, it is possible to improve the convenience when making the display device display the image.

In the aspect of the invention, in a case in which a format of the image data included in the image file is not a format the display device can process, the control section may convert the image data into image data having a format the display device can process, and then transmit the image data to the display device.

According to the aspect of the invention with this configuration, even if the format of the image data is the format which cannot be displayed by the display device, by converting the format of the image data into the format which can be processed by the display device in the electronic apparatus, it is possible to make the display device display the image.

Another aspect of the invention is directed to an electronic system including a first electronic apparatus having a conversion section adapted to convert a processing target file, which includes page data displayed in a page format, and text data associated with the page data, into the image file including the image data and the header, and a second electronic apparatus having an acquisition section adapted to obtain the image file from the first electronic apparatus, a communication section adapted to communicate with a display device, a display section, and a control section adapted to transmit the image data included in the image file obtained by the acquisition section to the display device using the communication section, retrieve text data from the header of the image file to display the text data on the display section.

According to the aspect of the invention, it is possible to make the display device display the image based on the image data included in the image file, and make the display section of the second electronic apparatus display the text data included in the image file. Therefore, it is possible to improve the convenience when making the display device display the image.

In the aspect of the invention, the conversion section may store the text data in a text chunk formed in the header of the image data.

According to the aspect of the invention with this configuration, it is possible to store the text data in the text chunk formed in the header. Therefore, it becomes unnecessary to set a new area for storing the text data in the image file, and it is possible to easily store the text data included in the processing target file in the image file.

In the aspect of the invention, in a case in which the processing target file includes the page data and an annotation associated with the page data, the conversion section may obtain the text data from the annotation to store the text data in the text chunk.

According to the aspect of the invention with this configuration, it is possible to store the text data, which is stored as the annotation in the processing target file, in the image file.

In the aspect of the invention, in a case in which a format of the image data included in the image file is not a format the display device can process, the control section may convert the image data into image data having a format the display device can process, and then transmit the image data to the display device.

According to the aspect of the invention with this configuration, even if the format of the image data is the format which cannot be displayed by the display device, by converting the format of the image data into the format which can be processed by the display device in the second electronic apparatus, it is possible to make the display device display the image.

In the aspect of the invention, the page data included in the processing target file may include at least either of an image and a text.

In the aspect of the invention, the conversion section may convert a file in a power point (registered trademark) format as the processing target file into an image file in one of a JPEG format, a GIF format, a PNG format, and a BMP format.

Another aspect of the invention is directed to a method of controlling an electronic apparatus having a display section and a communication section, the method including the steps of obtaining an image file including image data and a header, transmitting the image data included in the image file obtained to the display device with the communication section, and retrieving text data from the header of the image file and making the display section display the text data.

According to the aspect of the invention, it is possible to make the display device display the image based on the image data included in the image file, and make the display section of the electronic apparatus display the text data included in the image file. Therefore, it is possible to improve the convenience when making the display device display the image.

Another aspect of the invention is directed to a computer-readable recording medium storing a program which can be executed by a computer adapted to control an electronic apparatus having a display section and a communication section, the program making the computer execute a process including the steps of obtaining an image file including image data and a header, transmitting the image data included in the image file obtained to the display device with the communication section, and retrieving text data from the header included in the image file and making the display section display the text data.

According to the aspect of the invention, it is possible to make the display device display the image based on the image data included in the image file, and make the display section of the electronic apparatus display the text data included in the image file. Therefore, it is possible to improve the convenience when making the display device display the image.

### BRIEF DESCRIPTION OF THE DRAWINGS

The invention will be described with reference to the accompanying drawings, wherein like numbers reference like elements.

FIG. 1 is a system configuration diagram according to a first embodiment of the invention.

FIG. 2 is a configuration diagram of a PC.

FIG. 3 is a diagram showing an app screen.

FIG. 4 is a diagram showing an app screen.

FIG. 5 is a configuration diagram showing a configuration of a terminal device.

FIG. 6 is a diagram showing an app screen.

FIG. 7 is a diagram showing an app screen.

FIG. 8 is a configuration diagram of a projector.

FIG. 9 is a flowchart showing an operation of the PC.

FIG. 10 is a flowchart showing an operation of a terminal device.

FIG. 11 is a system configuration diagram according to a second embodiment of the invention.

FIG. 12 is a system configuration diagram according to a third embodiment of the invention.

### DESCRIPTION OF EXEMPLARY EMBODIMENTS

Some embodiments of the invention will hereinafter be described with reference to the accompanying drawings.

### First Embodiment

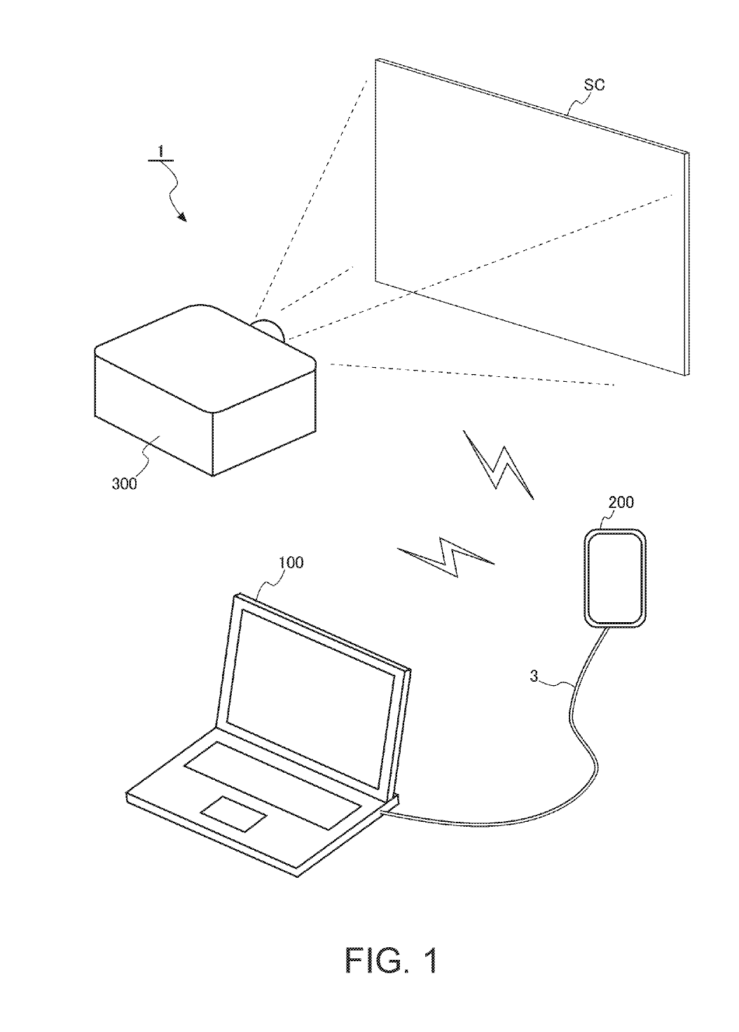

FIG. 1 is a system configuration diagram of an electronic system 1 according to a first embodiment to which the invention is applied.

The electronic system 1 is provided with a personal computer (hereinafter described as PC) 100 as a first electronic apparatus, a terminal device 200 as an electronic apparatus and a second electronic apparatus, and a projector 300 as a display device. The PC 100 can be a notebook PC, or can also be a desktop PC or a tablet PC. The terminal device 200 is a smart device such as a smartphone or a tablet PC. As the terminal device 200, it is possible to use a PDA (personal digital assistance) or a portable music player providing the device is provided with a communication function for performing wireless communication and a display screen.

The PC 100 and the terminal device 200 are connected to each other with a cable 3 compatible with, for example, wired LAN, IEEE 1394, USB, MHL (Mobile High-definition Link; registered trademark), or HDMI (High-Definition Multimedia Interface; registered trademark). Further, in the case in which the terminal device 200 is a PC, it is also possible to transfer data from the PC 100 to the terminal device 200 using a flash memory such as a USB memory or an SD card without connecting the PC 100 and the terminal device 200 to each other with the cable. Further, it is also possible for the PC 100 and the terminal device 200 to perform the communication with the wireless communication such as wireless LAN (local area network), Wi-Fi (registered trademark), or Wi-Fi Direct (registered trademark), or the near-field wireless communication such as Bluetooth (registered trademark) or BLE (Bluetooth Low Energy).

The terminal device 200 and the projector 300 perform the wireless communication such as wireless LAN or Wi-Fi Direct, or the near-field wireless communication such as Bluetooth or BLE. Further, it is also possible to connect the terminal device 200 and the projector 300 to each other with a cable such as an HDMI cable, an HML cable, or a USB cable.

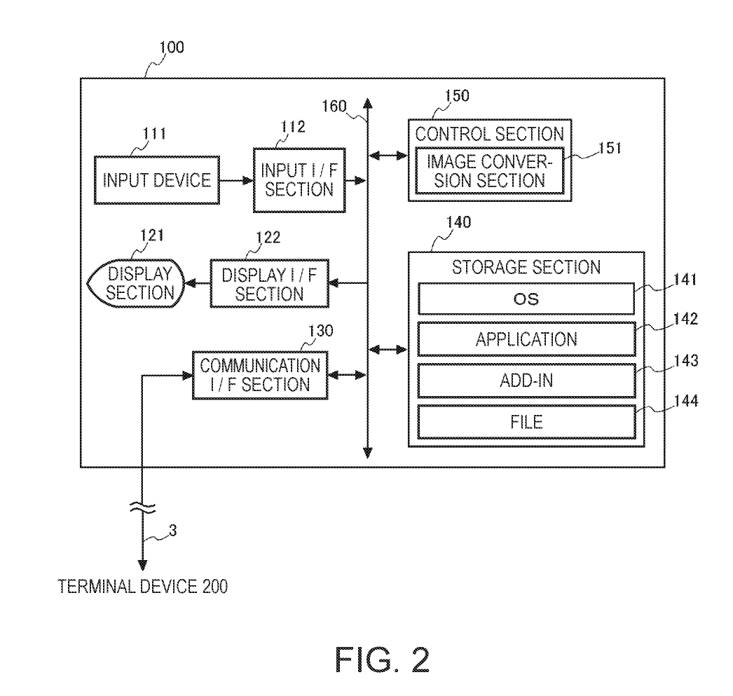

FIG. 2 is a configuration diagram showing a configuration of the PC 100.

The PC 100 performs an application program (hereinafter simply described as an application) to generate a file. The file generated by the PC 100 includes a document file generated with word processor software, spreadsheet software, or presentation software such as Power Point (registered trademark), and an image file generated with paint software, photo-retouching software, or the like.

The PC 100 includes an input device 111, an input interface section (the interface is hereinafter abbreviated as I/F) 112, a display section 121, a display I/F section 122, a communication I/F section 130, a storage section 140, and a control section 150. The input I/F section 112, the display I/F section 122, the communication I/F section 130, the storage section 140, and the control section 150 are connected to a bus 160, and perform data communication with each other via the bus 160.

The input device 111 is a pointing device such as a keyboard or a mouse. The input I/F 112 is formed of, for example, a general-purpose interface for an input device such as a USB interface, and detects an operation received by the input interface 111 to output an operation signal corresponding to the operation thus detected to the control section 150.

The display section 121 is a display device provided with a display surface such as a monitor of a display, and is connected to the display I/F section 122. The display section 121 displays an image of the display surface based on a display signal input from the display I/F section 122. The display I/F section 122 is connected to the display section 121 and the bus 160, and generates a display signal to be displayed on the display section 121 under the control of the control section 150, and then outputs the display signal to the display section 121.

The communication I/F section 130 is provided with a connector for wired connection to be connected to the terminal device 200 with wire, and an interface circuit corresponding to this connector. The connector is connected to the cable 3. As the connector and the interface circuit for the wired connection, there can be cited those compliant to wired LAN, IEEE 1394, USB, MHL, HDMI, or the like as described above.

The PC 100 performs transmission and reception of a file and a variety of types of control information with the terminal device 200 using the communication I/F section 130.

The storage section 140 is a nonvolatile storage device, and is formed of an auxiliary storage device such as a hard disk drive. The storage section 140 can be replaced with a flash memory or an optical disc such as compact disc (CD), digital versatile disc (DVD), or Blu-ray (registered trademark) disc (BD) capable of storing a large amount of information.

The storage section 140 stores the operating system (OS) 141 and an application 142 performed by the control section 150, and an add-in or add-on program 143 for expanding (adding) the function of the application 142. The program for expanding the function of the application 142 is hereinafter described as an add-in 143. Further, the storage section 140 stores a file 144 generated by the control section 150 performing the application 142 and the add-in 143.

The control section 150 is provided with a read only memory (ROM), a random access memory (RAM), and a central processing unit (CPU). The ROM is a nonvolatile memory, and stores the basic input output system (BIOS) and the firmware. The RAM is a volatile memory, and an OS 141, the application 142, and the add-in 143 retrieved from the storage section 140 are developed in the RAM. The CPU executes the OS 141, and the application 142, and the add-in 143 to thereby perform a variety of processes.

The control section 150 is provided with an image conversion section 151 as a functional block. The image conversion section 151 corresponds to a “conversion section” according to the invention. The function block is the function, which is realized by the CPU executing these programs developed in the RAM, expressed as a block in an expedient manner, but does not mean a specific application nor hardware. The image conversion section 151 is a functional section, which is operated by the control section 150 executing the add-in 143 related to presentation software included in the application 142 when the control section 150 executes the presentation software.

Although in the present embodiment, there is described the case in which the add-in 143 is executed by the control section 150, and the control section 150 acts as the image conversion section 151, it is also possible to make the image conversion section 151 act as a separate and independent program. Further, it is also possible to configure the add-in 143 as a program operating in association with word-processing software, spreadsheet software, an e-mail program, paint software, photo-retouching software, accounting software, and so on.

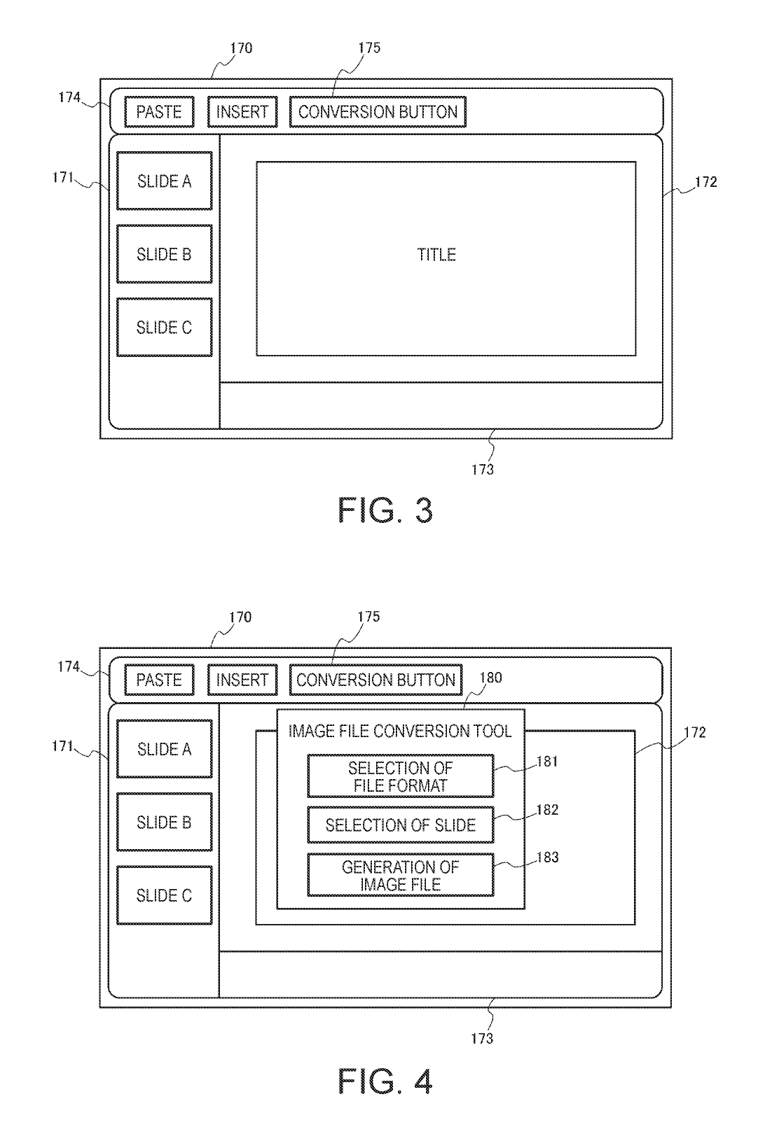

FIG. 3 is a diagram showing a screen (hereinafter referred to as an app screen) displayed on the display section 142 by the control section 150 executing the presentation software.

In the app screen 170, there are displayed a thumbnail display section 171, an edit section 172, annotation section 173, a toolbar 174, and so on. The annotation section 173 corresponds to an “annotation” according to the invention.

In the thumbnail display section 171, there are displayed thumbnails of slides generated, and identification information of the slides.

In the edit section 172, there is displayed the slide to be the edit target out of the slides displayed in the thumbnail display section 171. The user selects a function of the presentation software displayed in the toolbar 174 to perform an editorial operation on the slide displayed in the edit section 172 using the function thus selected. Here, the slides are each page data displayed in a page format, and data including at least either of an image and a text.

In the annotation section 173, there is displayed text data as a note (an annotation). The user operates the input device 111 to input the text data to the annotation section 173. The text data is a text related to the slide displayed in the edit section 172. When, for example, explaining the slide in the presentation, the user writes a note obtained by summing up what to be spoken and so on in the annotation section 173.

In the control section 150 stores the text data input to the annotation section 173 in the RAM in conjunction with the identification information of the slide displayed in the edit section 172. In the case of receiving an exit operation of the application 142, the control section 150 generates a document file including the slide thus generated and the text data. The document file also includes the data representing the correspondence relationship between the slide and the text data.

In the toolbar 174, there are displayed buttons (e.g., a button for attachment and a button for insertion) to which the functions of the presentation software are assigned. Further, in the toolbar 174, there is displayed a conversion button 175. When receiving the operation of selecting the conversion button 175 by the input device 111, the control section 150 executes the add-in 143 to make the image conversion section 151 function. The image conversion section 151 converts the processing target file, which includes the slide as the page data, and the text data associated with the slide, into an image file including the image data and a header. In the present embodiment, there will be described the case in which the image conversion section 151 converts the file in the power point format as the processing target film into an image file in the PNG format.

FIG. 4 is a diagram showing the screen (hereinafter referred to as an add-in screen) 180 to be displayed in the app screen 170 in the case in which the operation of selecting the conversion button 175 has been received.

When the conversion button 175 is selected, the image conversion section 151 displays the add-in screen 180 in the app screen 170. In this add-in screen 180, there are displayed, for example, a format selection button 181, a slide selection button 182, and a generation button 183. The format selection button 181 is a button for selecting the format (e.g., JPEG, PNG (portable network graphics), GIF, and BMP) of the image file to be generated. The format of the image file to be selected by the format selection button 181 is a format provided with an area for storing the text data is disposed in a header area of the image file such as JPEG, GIF, PNG, or BMP. For example, the JPEG image file is provided with an area for storing the text data in the COM segment. Further, the PNG image file is provided with an area for storing the text data in a text chunk of a header area. The GIF image file is provided with an area for storing the text data in a Comment Extension Block. It should be noted that the size of the area capable of storing the text data differs by the format of the image file. Further, the format of the image file which can be selected by the format selection button 181 is not limited to the format provided with the area for storing the text data, but it is possible to adopt an image file having a format not provided with the area capable of storing the text data. The slide selection button 182 is a button for selecting the slide to be converted into the image file. The generation button 183 is a button for making the image conversion section 151 perform the conversion process for converting the slide thus selected into the image file.

The user selects the format selection button 181 using the input device 111 to select the file format of the image file. Further, the user selects the slide selection button 182 using the input device 111 to select the slide or the file to be converted into the image file. As the slide to be converted into the image file, one slide or a plurality of slides can be selected. In the image file having the PNG format, it is possible to include a plurality of image data in one image file. Further, although in the present embodiment, there is described the case of converting the one slide or the plurality of slides into the image file, it is also possible to convert the file having the power point format as the processing target file into the image file.

When the generation button 183 is selected using the input device 111 in the state in which the file format and the slide have been selected, the image conversion section 151 determines whether or not the text data is associated with the slide thus selected. It is also possible for the image conversion section 151 to display a message like “DO YOU LEAVE A NOTE?” on the app screen 170 in the case in which the text data is associated with the slide.

Further, it is also possible for the image conversion section 151 to determine whether or not the format of the file thus selected is the format, in which the text data can be stored in the image file, in the case in which the image file not provided with the area for storing the text data can be selected by the format selection button 181. In the case in which the format of the image file thus selected is not the format capable of storing the text data, the image conversion section 151 displays the message such as “IS IT OK TO ERASE THE NOTE?” in the app screen 170. Then, the image conversion section 151 displays the file format of the image file capable of storing the text data in the app screen 170 to prompt the user to change the file format of the image file.

Further, it is also possible for the image conversion section 151 to determine whether or not the size of the text data associated with the slide is larger than the data size of the text data which can be stored in the image file. In the case in which the size of the text data associated with the slide is larger than the size of the data which can be stored in the image file, the image conversion section 151 displays the message such as “A PART OF THE NOTE CANNOT BE STORED” in the app screen 170. Then, the image conversion section 151 displays the file format of the image file capable of storing the text data in the app screen 170 to prompt the user to change the file format of the image file.

When the selection of leaving the note has been received by the input device 111 and the image file having the file format capable of storing the text data has been selected, the image conversion section 151 converts the slide thus selected into the image file having the format thus selected. Further, the image conversion section 151 stores the text data associated with the slide thus converted in the text chunk prepared in the header area of the image file thus converted. On this occasion, the image conversion section 151 performs the conversion of the file format so as to keep the association between the slide and the text data set in the file before the conversion. Specifically, the image conversion section 151 converts the slide into the image data, and then associates the text data, which is associated with the slide having been converted into the image data, with the image data thus converted. For example, the image conversion section 151 uses the identification information attached to the slide as the identification information of the image data obtained by converting the slide to associate the text data, which is associated with the slide, with the image data having the same identification information.

Further, the image conversion section 151 has received the input of the file name of the image file thus generated, and the filename has been set by the user, the image conversion section 151 stores the image file in the storage section 140.

The control section 150 transmits the list of the file names of the image files stored in the storage section 140 to the terminal device 200 in accordance with the request from the terminal device 200. Then, when the control section 150 receives the file name of the image file thus selected from the terminal device 200, the control section 150 retrieves the image file having the file name thus received from the storage section 140, and then transmits the image file to the terminal device 200 by the communication I/F section 130.

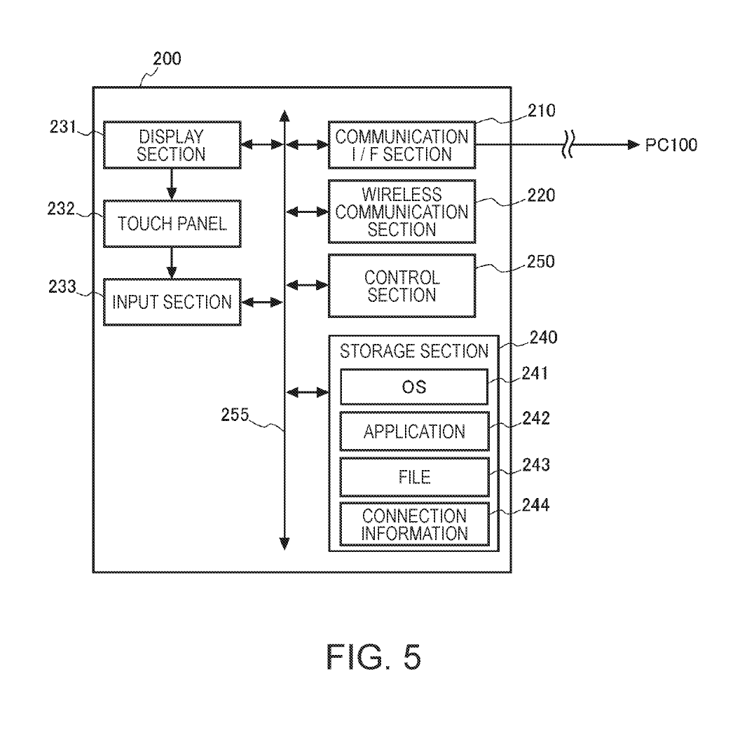

FIG. 5 is a configuration diagram showing a configuration of the terminal device 200.

The terminal device 200 is provided with a communication I/F section 210, a wireless communication section 220, a display section 231, a touch panel 232, an input section 233, a storage section 240, and a control section 250. The communication I/F section 210, the wireless communication section 220, the display section 231, the input section 233, the storage section 240 and the control section 250 are connected to each other with a bus 255 so as to be able to be communicated with each other. The wireless communication section 220 corresponds to a “communication section” according to the invention. The touch panel 232 corresponds to a “display section” according to the invention. By the communication I/F section 210 and the control section 250 acting in cooperation with each other to thereby act as an “acquisition section” according to the invention. Further, the control section 250 also acts as a “control section” according to the invention.

The communication I/F section 210 is provided with a connector for wired connection to be connected to the PC 100 as external equipment with wire, and an interface circuit corresponding to the connector. As the connector and the interface circuit for the wired connection, there can be cited those compliant with wired LAN, IEEE 1394, USB, MHL, HDMI or the like. The terminal device 200 performs transmission and reception of a data file and a variety of types of control information with the PC 100 using the communication I/F section 210.

The wireless communication section 220 is provided with an antenna, an RF (radio frequency) circuit, and so on not shown, and performs the wireless communication with an external device under the control of the control section 250. The wireless communication method of the wireless communication section 220 can be what is compliant with the wireless communication standard such as wireless LAN or Wi-Fi Direct, or can also be what is compliant with the near-field wireless communication standard such as Bluetooth or BLE. Further, as the wireless communication method of the wireless communication section 220, it is possible to adopt the wireless communication method using the cellular phone line.

The display section 231 and the input section 233 are connected to the touch panel 232. The display section 231 displays the display screen on the touch panel 232 under the control of the control section 250. The input section 233 detects a contact operation in the touch panel 232 to output coordinate data representing the position of the operation thus detected to the control section 250.

The storage section 240 is a nonvolatile storage device, and is formed of an auxiliary storage device such as a hard disk drive. The storage section 240 can be replaced with a flash memory or an optical disc such as CD, DVD, or BD capable of storing a large amount of information.

The storage section 240 stores a program such as an OS 241 and an application 242 executed by the control section 250. Further, the storage section 240 stores a variety of types of data such as a file 243 and connection information 244. The file 243 includes the image file received from the PC 100.

The connection information 244 is the information for the wireless communication section 220 to hook up with the projector 300 with the wireless communication. For example, the connection information 244 includes the MAC (media access control) address, the IP (internet protocol) address, the network name, the SSID (service set identifier), and so on of the terminal device 200. Further, the connection information 244 can also include the SSID, the type of the security setting, the password or the passkey, the terminal name, and so on of the destination equipment. The security setting can be selected from, for example, WEP (wired equipment privacy) and WPA (Wi-Fi protected access).

The control section 250 is provided with a CPU (processor) as hardware, executes the program such as the OS 241 and the application 242 stored in the storage section 240 to control the sections of the terminal device 200.

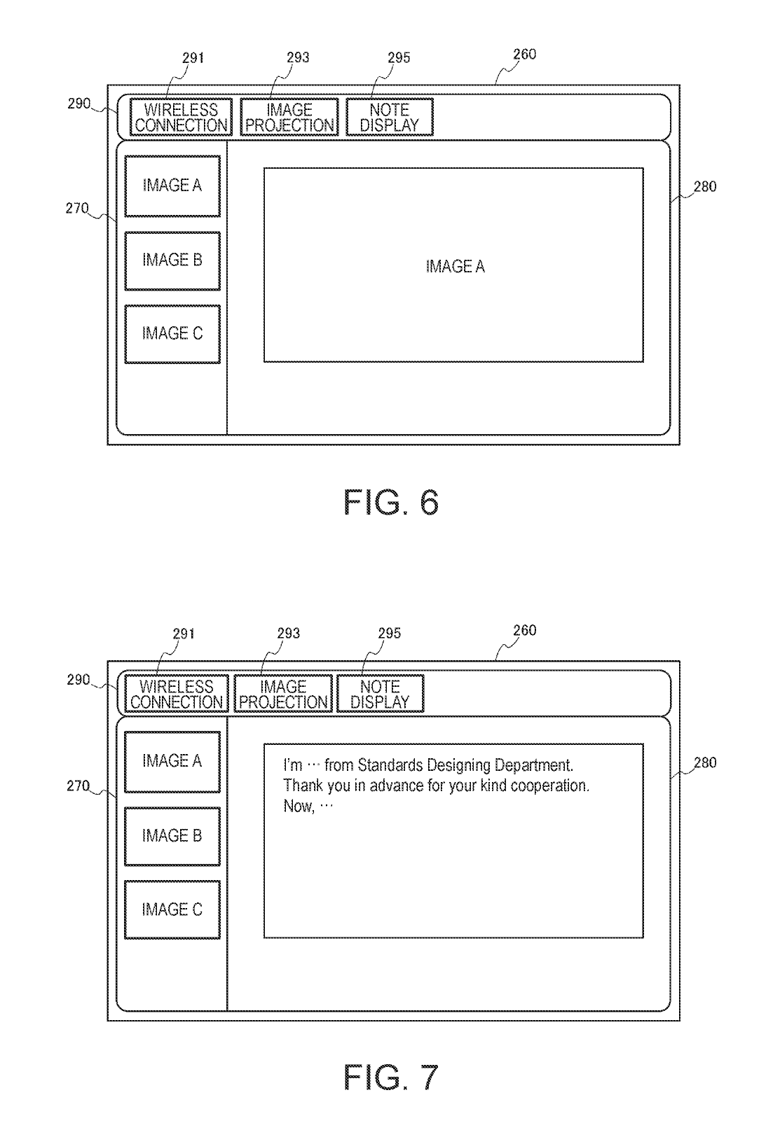

FIG. 6 and FIG. 7 are each a diagram showing a display screen (an app screen) 260 displayed on the touch panel 232 by the control section 250 executing the application 242.

When the application 242 is selected by the operation received by the touch panel 232, the control section 250 displays the app screen 260 shown in FIG. 6 on the touch panel 232.

In the app screen 260, there are displayed a thumbnail display section 270, an image display section 280, a tool bar 290, and so on.

In the thumbnail display section 270, the thumbnails of the image data included in the image file are displayed as a list. This image file is an image file stored in the storage section 240, and is an image file selected by the user operating the touch panel 232.

In the image display section 280, there is displayed the image data. When the image projection button 293 displayed in the toolbar 290 is selected, the image data displayed in the image display section 280 is transmitted by the control section 250 to the projector 300, and is then projected by the projector 300 on the screen SC.

In the toolbar 290, there are displayed, for example, a button 291 for the wireless connection, a button 293 for the image projection, and a button 295 for the note display. The button 291 for the wireless connection is a button for wirelessly connecting the terminal device 200 and the projector 300 to each other. When the button 291 for the wireless connection is selected, the control section 250 refers to the connection information 244 to establish the wireless communication with the projector 300.

The button 293 for the image projection is a button for transmitting the image data to the projector 300 to start the image projection to the screen SC.

When the button 293 for the image projection is selected, and one image datum is selected from the image data displayed in the thumbnail display section 270, the control section 250 determines the format of the image data thus selected. In the case in which the format of the image data thus selected is not the format which can be processed in the projector 300, the control section 250 converts the format of the image data to generate the image data to be displayed by the projector 300. The control section 250 transmits the image data the format of which has been converted to the projector 300 to display the image data on the screen SC. Further, the control section 250 displays the image of the image data thus selected in the image display section 280.

FIG. 7 is a diagram showing the app screen 260 to be displayed on the touch panel 232 in the case in which the button 295 for the note display has been selected.

In the case in which the image file has been selected by the user, and the thumbnail of the image data included in the image file thus selected is displayed in the thumbnail display section 270, the control section 250 retrieves the text data stored in the text chunk from the image file. The control section 250 stores the text data thus retrieved, and the identification information of the image data with which the text data has been associated in the RAM so as to be associated with each other. Each of the image data included in the image file is provided with the identification information.

Further, when the button 295 for the note display is selected in the state in which the image is displayed in the image display section 280, the control section 250 obtains the text data, which is associated with the image data of the image thus displayed, with reference to the RAM. Then, the control section 250 displays the text based on the text data thus obtained in the image display section 280, in which the image has been displayed up to that moment. The text displayed in the image display section 280 is not projected by the projector 300 on the screen SC, but can visually be recognized only by the user of the terminal device 200.

Further, when another thumbnail is selected from the thumbnails displayed in the thumbnail display section 270, the control section 250 transmits the image data corresponding to the thumbnail thus selected to the projector 300 to project the image data on the screen SC. Further, the control section 250 obtains the text data associated with the image data having been transmitted to the projector 300 from the RAM, and then displays the text based on the text data thus obtained in the image display section 280. Therefore, it is possible for the user of the terminal device 200 to perform the explanation of the image projected on the screen SC while looking up the touch panel 232 of the terminal device 200.

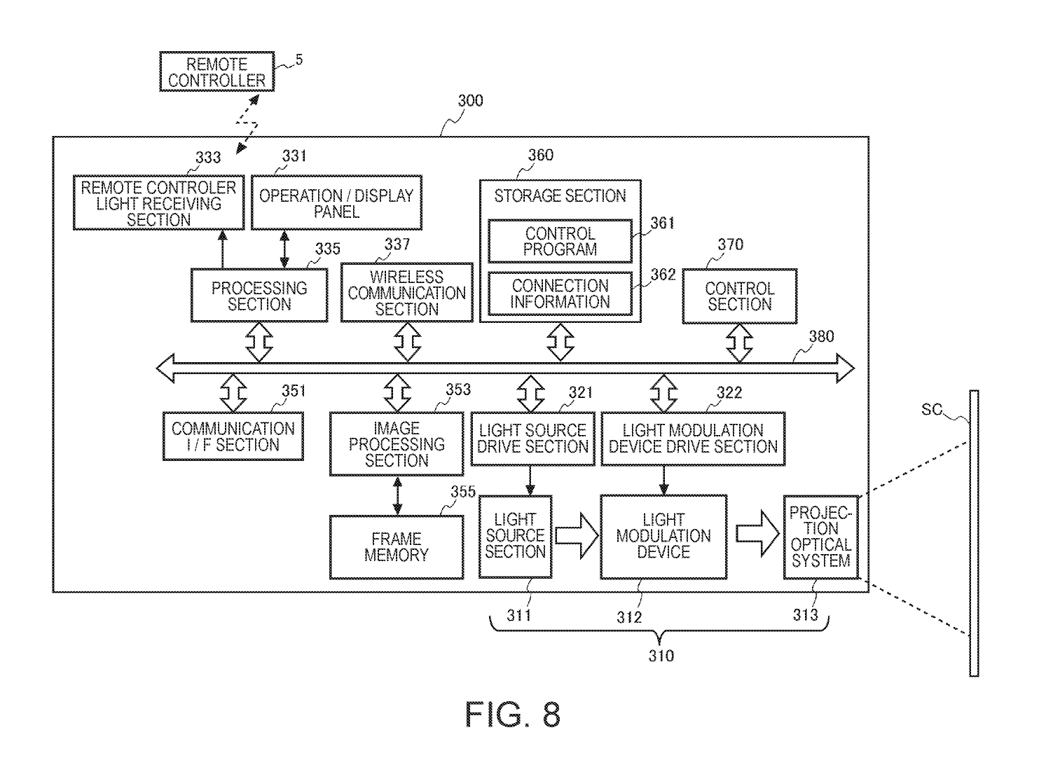

FIG. 8 is a configuration diagram showing a configuration of the projector 300.

The projector 300 is provided with a communication I/F section 351. The communication I/F section 351 is provided with a connector for wired connection to be connected to the external device (not shown) with wire, and an interface circuit corresponding to the connector. As the connector and the interface circuit for the wired connection, there can be cited those compliant with wired LAN, IEEE 1394, USB, MHL, HDMI or the like. The projector 300 performs transmission and reception of a data file and a variety of types of control information with the external device using the communication I/F section 351.

The projector 300 is provided with a display section 310 for performing formation of an optical image to project the image on the screen SC. The display section 310 is provided with a light source section 311, a light modulation device 312, and a projection optical system 313.

The light source section 311 is provided with a light source such as a xenon lamp, a super-high pressure mercury lamp, a light emitting diode (LED), or a laser source. Further, the light source section 311 can also be provided with a reflector and an auxiliary reflector for guiding the light emitted by the light source to the light modulation device 312. Further, the light source section 311 can also be provided with a lens group for improving the optical characteristics of the projection light, a polarization plate, a dimming element for reducing the light intensity of the light emitted by the light source on a path leading to the light modulation device 312, and so on (all not shown).

The light source section 311 is driven by a light source drive section 321. The light source drive section 321 is connected to the light source section 321 and a bus 380. The light source drive section 321 switches between lighting and extinction of the light source of the light source section 311 under the control of a control section 370 described later.

The light modulation device 312 is provided with, for example, three liquid crystal panels corresponding respectively to the three primary colors of RGB. The light emitted by the light source section 311 is separated into colored light beams of three colors of RGB, and the colored light beams respectively enter the corresponding liquid crystal panels. The three liquid crystal panels are each a transmissive liquid crystal panel, on which an image based on the image data is drawn by the light modulation device drive section 322. The light modulation device 312 modulates the colored light beams entering the light modulation device 312 with the liquid crystal panels on which the images are respectively drawn to thereby generate image light beams. The image light beams, which have been modulated while passing through the respective liquid crystal panels, are combined by a combining optical system such as a cross dichroic prism, and are then output to the projection optical system 313.

The light modulation device 312 is driven by a light modulation device drive section 322. The light modulation device drive section 322 is connected to the light modulation device 312 and the bus 380. The light modulation device drive section 322 drives the three liquid crystal panels based on the image data input from an image processing section 353 described later to thereby draw images based on the image data on the respective liquid crystal panels.

The projection optical system 313 is provided with a lens group for projecting the image light, which has been modulated by the light modulation device 312, toward the screen SC to form the image on the screen SC. Further, the projection optical system 313 can also be provided with a zoom mechanism for expanding or contracting the projection image projected on the screen SC, and a focus adjustment mechanism for performing an adjustment of the focus.

The projector 300 is provided with an operation/display panel 331, a remote control light receiving section 333, and a processing section 335. The processing section 335 is connected to the operation/display panel 331, the remote control light receiving section 333, and the bus 380.

The operation/display panel 331 functioning as a user interface is provided with a variety of types of operation keys, and a display panel using a liquid crystal display (LCD) or the like. When the operation key of the operation/display panel 331 is operated, the processing section 335 outputs the operation signal corresponding to the key thus operated to the control section 370. Further, the operation/display panel 331 is stacked with a touch sensor for detecting contact with the operation/display panel 331 to form a touch panel. The processing section 335 detects the position of the operation/display panel 331 at which a finger of the user or the like has contact with the operation/display panel 331 as an input position, and then outputs the coordinate data corresponding to the input position thus detected to the control section 370.

Further, the processing section 335 displays a variety of types of display screens on the operation/display panel 331 based on the control signal input from the control section 370.

The remote control light receiving section 333 receives an infrared signal transmitted from the remote controller 5. The remote controller 5 is provided with a variety of types of buttons, and transmits the infrared signal in accordance with the operation of these buttons. The processing section 335 decodes the infrared signal received by the remote control light receiving section 333 to generate an operation signal representing the operation content in the remote controller 5, and then outputs the operation signal to the control section 370.

The projector 300 is provided with a wireless communication section 337. The wireless communication section 337 is connected to the bus 380. The wireless communication section 337 is provided with an antenna, an RF circuit, and so on not shown, and performs the wireless communication with an external device under the control of the control section 370. The wireless communication method of the wireless communication section 337 can be what is compliant with the wireless communication standard such as wireless LAN or Wi-Fi Direct, or can also be what is compliant with the near-field wireless communication standard such as Bluetooth or BLE. Further, as the wireless communication method of the wireless communication section 220, it is possible to adopt the wireless communication method using the cellular phone line.

The projector 300 is provided with an image processing system. The image processing system is constituted by the control section 370 for performing overall control of the whole of the projector 300 as a central constituent, and is provided with the image processing section 353, a frame memory 355, and a storage section 360 besides the control section 370. The control section 370, the image processing section 353, and the storage section 360 constituting the image processing system are connected to each other with the bus 380 so as to be able to perform data communication.

The image data having been received by the communication I/F section 351 or the wireless communication section 337 are stored in the frame memory 355 due to the control of the control section 370. The image processing section 353 retrieves the image data from the frame memory 355 to perform the image processing. The process performed by the image processing section 353 includes, for example, a resolution conversion (scaling) process or a resizing process, a shape correction process such as a distortion correction, a digital zooming process, a color compensation process, and a luminance correction process. The image processing section 353 performs the process designated by the control section 370, and performs the process using a parameter input from the control section 370 as needed. Further, it is obviously possible for the image processing section 353 to perform two or more of the processes described above in combination with each other. The image data on which the image processing has been performed by the image processing section 353 is stored once in the frame memory 355, and is then retrieved from the frame memory 355 at a predetermined timing to be output to the light modulation device drive section 322.

The storage section 360 is an auxiliary storage device such as a hard disk drive. The storage section 360 can be replaced with a flash memory or an optical disc such as CD, DVD, or BD capable of storing a large amount of information.

The storage section 360 stores the control program 361 to be executed by the control section 370. Further, the storage section 360 stores connection information 362.

The connection information 362 includes a variety of types of information for performing the communication with the terminal device 200, and information for identifying the terminal device 200. Specifically, the connection information 362 can include the MAC address, the IP address, the network name, the SSID of the terminal device 200, the type of the security setting, the SSID, the password or passkey, the terminal name, and so on of the wireless communication with the terminal device 200.

The control section 370 is provided with a CPU, a ROM, and a RAM (all not shown) as the hardware. The ROM is a nonvolatile storage device such as a flash ROM, and stores a control program such as firmware executed by the control section 370. The RAM is used as a working area for the CPU. The CPU executes the control program 361 developed in the RAM to control the sections of the projector 300.

The control section 370 controls the sections of the projector 300 to control the projection of the image to the screen SC. For example, the control section 370 controls the light modulation device drive section 322 to draw the images based on the image data on the liquid crystal panels of the light modulation device 312.

Further, the control section 370 controls the light source drive section 321 to control lighting and extinction of the light source section 311. Further, the control section 370 controls the light source drive section 321 to control the luminance of the light source section 311 having been lit. Further, the control section 370 drives the motor not shown to operate the zoom mechanism and the focus adjustment mechanism installed in the projection optical system 313 to perform the adjustment of the zoom and the focus.

The control section 370 controls the communication I/F section 351 to control the communication with the external device. Further, the control section 370 establishes the wireless communication with the terminal device 200 with reference to the connection information 362.

When the wireless communication with the terminal device 200 has been established and the image data has been transmitted from the terminal device 200, the projector 300 receives the image data with the wireless communication section 337. The image data having been received by the wireless communication section 337 is stored in the frame memory 355 by the image processing section 353. The image processing section 353 retrieves the image data from the frame memory 355 to perform the image processing on the image data thus retrieved. The image data processed by the image processing section 353 is output to the light modulation device drive section 322, and the light modulation device drive section 322 draws the images based on the image data thus input on the liquid crystal panels of the light modulation device 312. The light having emitted from the light source section 311 is modulated by the liquid crystal panels, on which the images have been drawn, into the image light beams, and then the image light beams are projected by the projection optical system 313 on the screen SC.

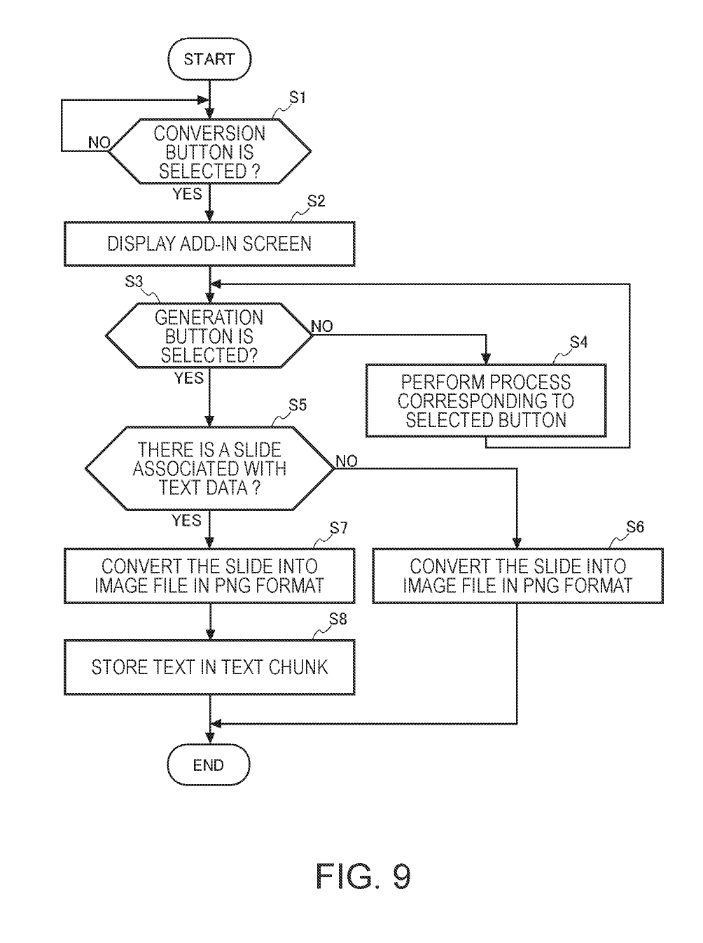

FIG. 9 is a flowchart showing the operation of the PC 100.

This flowchart is started in the state in which the application 142 is selected, and the app screen 170 of the application 142 selected is displayed on the display section 121. Further, the presentation software is selected as the application 142, and the conversion button 175 is displayed in the app screen 170.

The control section 150 firstly receives the operation with the input device 111, and then determines (step S1) whether or not the operation thus received is the operation for selecting the conversion button 175. In the case in which the operation received is not the operation for selecting the conversion button 175 (NO in the step S1), the control section 150 performs the process corresponding to the operation thus received, and does not perform the operation shown in the flowchart until the conversion button 175 is selected. Further, in the case in which the operation having been received is the operation for selecting the conversion button 175 (YES in the step S1), the control section 150 displays (step S2) the add-in screen 180 shown in FIG. 4.

Then, the control section 150 determines (step S3) whether or not the operation of selecting the generation button 183 has been received by the input device 111. In the case in which the generation button 183 is not selected (NO in the step S3), the control section 150 performs (step S4) the process corresponding to the format selection button 181 or the slide selection button 182 thus selected. For example, in the case in which the format selection button 181 has been selected, the control section 150 receives the selection of the file format of the image file to be generated, and in the case in which the slide selection button 182 has been selected, the control section receives the selection of the slide to be converted into the image file.

Further, in the case in which the generation button 183 has been selected (YES in the step S3), the control section 150 determines (step S5) whether or not the slide associated with the text data exists in the slides to be converted into the image file. In the case in which the slide associated with the text data does not exist (NO in the step S5), the control section 150 converts (step S6) the slide(s) thus selected into the image file in the PNG format.

Further, in the case in which the slide associated with the text data exists (YES in the step S5), the control section 150 converts (step S7) the slide(s) thus selected into the image file in the PNG format. Then, the control section 150 stores (step S8) the text data associated with the slide in the text chunk of the image file obtained by the conversion. The control section 150 generates the image file, and then stores the image file thus generated in the storage section 140. Further, when the control section 150 receives an acquisition request of the image file thus generated from the terminal device 200, the control section 150 transmits the image file thus generated to the terminal device 200.

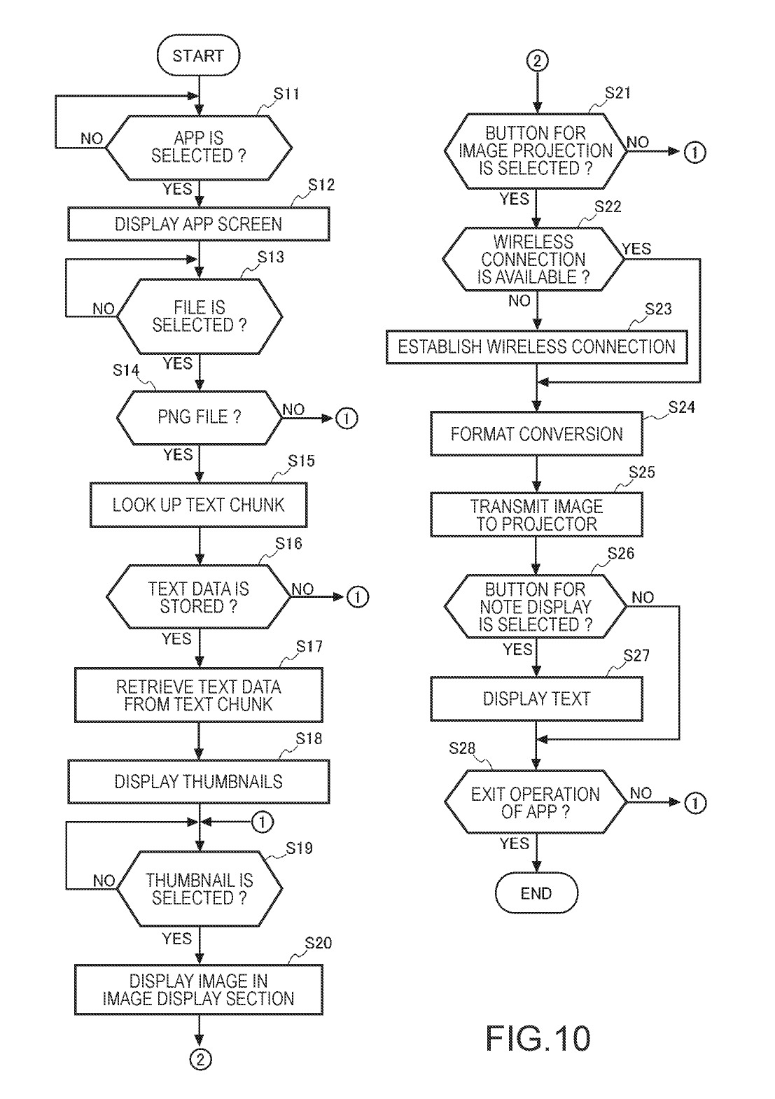

FIG. 10 is a flowchart showing the operation of the terminal device 200.

When the control section 250 of the terminal device 200 receives the operation of the touch panel 232, the control section 250 determines (step S11) whether or not the operation thus received is the operation for selecting the application 242. In the case in which the operation is not the operation for selecting the application 242 (NO in the step S11), the control section 250 performs another process corresponding to the operation thus received. Further, in the case in which the operation for selecting the application 242 has been received (YES in the step S11), the control section 250 makes the touch panel 232 display (step S12) the app screen 260 shown in FIG. 6.

After making the touch panel 232 display the app screen 260, the control section 250 displays the file names of the files 243 stored in the storage section 240 as a list, and then receives (step S13) the selection of the files 243. In this flow, the control section 250 does not wait for the execution of other processes until the file 243 is selected (NO in the step S13), but it is also possible to perform other processes such as wirelessly hooking up with the projector 300. When the file 243 has been selected (YES in the step S13), the control section 250 determines (step S14) whether or not the file thus selected is the PNG file. In the case in which the file selected is not the PNG file (NO in the step S14), the control section 250 makes the transition to the process of the step S19. Further, in the case in which the file is the PNG file (YES in the step S14), the control section 250 determines (step S16) whether or not there exists the text chunk storing the text data with reference (step S15) to the text chunk of the PNG file thus selected. In the case in which the text chunk storing the text data does not exist (NO in the step S16), the control section 250 makes the transition to the process of the step S19. Further, in the case in which the text chunk storing the text data exists (YES in the step S16), the control section 250 retrieves (step S17) the text data from the text chunk. The control section 250 stores the text data thus retrieved in the RAM so as to be associated with the identification information of the image data.

Then, the control section 250 displays (step S18) the thumbnails of the image data included in the PNG file thus selected in the thumbnail display section 270. Then, the control section 250 determines (step S19) whether or not the operation of selecting the thumbnail has been received by the operation of the touch panel 232. In the case in which the selection of the thumbnail has not been received (NO in the step S19), the control section 250 waits until the thumbnail is selected. Further, when the thumbnail is selected (YES in the step S19), the control section 250 displays (step S20) the image data corresponding to the thumbnail thus selected in the image display section 280.

Then, the control section 250 determines (step S21) whether or not the operation of selecting the button 293 for the image projection has been received. In the case in which the operation of selecting the button 293 for the image projection has not been received (NO in the step S21), the control section 250 returns to the determination of the step S19, and if the thumbnail is selected, the control section 250 display the image data corresponding to the thumbnail thus selected in the image display section 280.

Further, in the case in which the operation of selecting the button 293 for the image projection has been received (YES in the step S21), the control section 250 determines (step S22) whether or not the wireless connection with the projector 300 has been established. In the case in which the wireless connection with the projector 300 has not been established (NO in the step S22), the control section 250 establishes (step S23) the wireless connection with the projector 300 with reference to the connection information 244. Further, in the case in which the wireless connection with the projector 300 has been established (YES in the step S22), the control section 250 makes the transition to the process of the step S24.

The control section 250 performs (step S24) the format conversion of the image data in the step S24. The control section 250 converts the format of the image data thus selected into the format of the image data, which the projector 300 can decode. Then, the control section 250 transmits (step S25) the image data thus converted to the projector 300.

Then, the control section 250 determines (step S26) whether or not the button 295 for the note display has been selected due to the operation of the touch panel 232. In the case in which the button 295 for the note display has been selected (YES in the step S26), the control section 250 obtains the text data associated with the image data having been transmitted to the projector 300, and then displays (step S27) the text data in the image display section 280. Further, in the case in which the button 295 for the note display has not been selected (NO in the step S26), the control section 250 determines (step S28) whether or not an exit operation for terminating the application has been received due to the operation of the touch panel 232. In the case in which the exit operation has been received (YES in the step S28), the control section 250 stores the image file in the storage section 240, and then terminates the processing flow. Further, in the case in which the exit operation has not been received (NO in the step S28), the control section 250 returns to the step S19 to repeat the process of the step S19 and the subsequent steps.

As described hereinabove, the terminal device 200 according to the present embodiment is provided with the wireless communication section 220, the touch panel 232, and the control section 250.

The control section 250 obtains the image file including the image data and the header, and then transmits the image data included in the image file thus obtained to the projector 300 with the wireless communication section 220. Further, the control section 250 retrieves the text data from the header of the image file to make the touch panel 232 display the text data.

Therefore, it is possible to make the projector 300 display the image based on the image data included in the image file, and make the touch panel 232 of the terminal device 200 display the text data included in the image file. Therefore, it is possible to improve the convenience when making the projector 300 display the image.

Further, in the case in which the format of the image data included in the image file is not the format the projector 300 can process, the control section 250 converts the image data into the image data having the format the projector 300 can process, and then transmits the result to the projector 300.

Therefore, even if the format of the image data is the format which the projector 300 cannot display, it is possible to make the projector 300 display the image.

The PC 100 is provided with the image conversion section 151 for converting the processing target file, which includes the page data displayed in the page format, and the text data associated with the page data, into the image file including the image data and the header.

Therefore, in the case in which the format of the processing target file is the format which cannot be processed by the terminal device 200, it is possible to convert the processing target file into the image file which can be processed by the terminal device 200, and then transmit the image file obtained by the conversion to the terminal device 200.

Further, in the case in which text data is included in the processing target file, it is possible to store the text data in the image file without deleting the text data.

Therefore, it is possible to improve the convenience when making the projector 300 display the image.

Further, the image conversion section 151 stores the text data in the text chunk formed in the header of the image data. Therefore, it becomes unnecessary to set a new area for storing the text data in the image file, and it is possible to easily store the text data included in the processing target file in the image file.

Further, in the case in which the processing target file includes the page data and the annotation associated with the page data, the image conversion section 151 obtains the text data from the annotation to store the text data in the text chunk.

Therefore, it is possible to store the text data, which is stored as the annotation in the processing target file, in the image file.

Further, in the case in which the format of the image data included in the image file is not the format the projector 300 can process, the control section 250 converts the image data into the image data having the format the projector 300 can process, and then transmits the result to the projector 300.

Therefore, even if the format of the image data is the format which cannot be displayed by the projector 300, by converting the format of the image data into the format which can be processed by the projector 300 in the terminal device 200, it is possible to make the projector 300 display the image.

### Second Embodiment

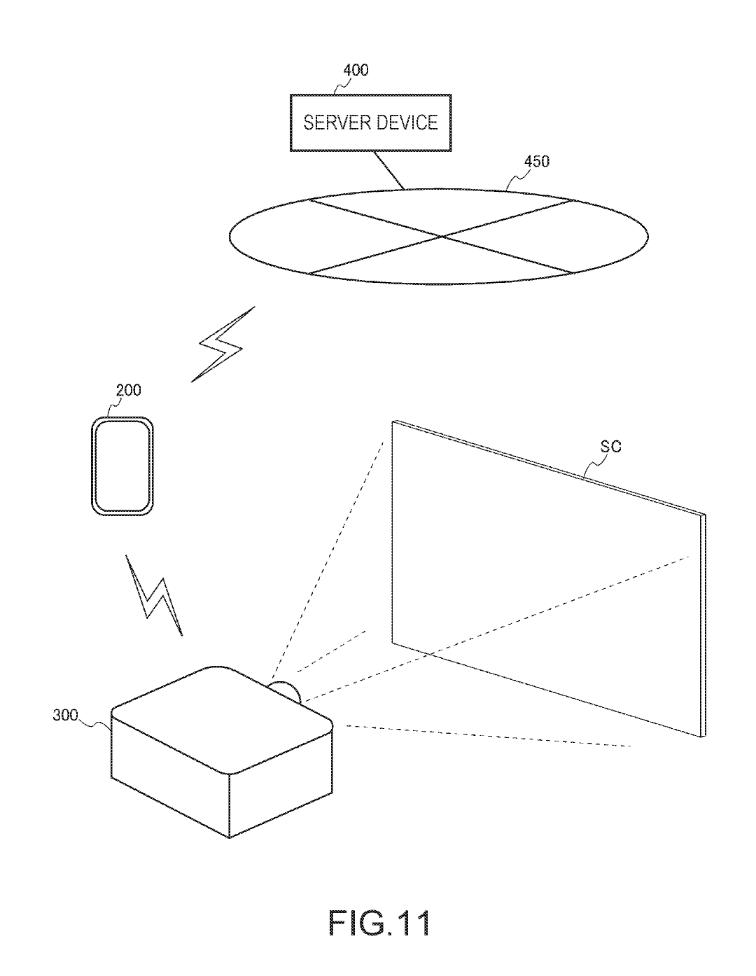

FIG. 11 is a system configuration diagram according to a second embodiment of the invention.

The second embodiment is provided with a server device 400 connected to a network 450 instead of the PC 100. The terminal device 200 is connected to the server device 400. For example, in the case in which the terminal device 200 is a smartphone, the terminal device 200 hook up with the wireless station via the cellular phone line to perform the data communication with the server 400 on the network 450. Further, it is also possible for the terminal device 200 to hook up with the access point via the wireless LAN or the like to perform the data communication with the server 400 on the network 450. Further, it is also possible to adopt a configuration in which the terminal device 200 is connected to the network 450 via the wired LAN or the like to be able to perform the data communication with the server device 400.

In the first embodiment, in the PC 100, the document file in the presentation format is converted into the image file, and then the text date is stored in the text chunk of the image file obtained by the conversion. In the second embodiment, the image file in which the text data is stored in the text chunk is generated in the terminal device 200. However, in the case in which the terminal device 200 does not support the document file, it is not possible to open the document file in the terminal device 200.

When a document file is received or input from the external device (e.g., a PC or a USB memory), the terminal device 200 stores the document file in the storage section 240. The document file is a file having the text data as a note associated with a slide. Further, when the transmission of the document file to the server device 400 has been instructed due to the operation of the touch panel 232, the terminal device 200 transmits the document file selected to the server device 400.

When the server 400 receives the document file from the terminal device 200, the server 400 converts the document file received into an image file of a format such as JPEG, PNG, or GIF. The file format to be converted can be designated by the terminal device 200. The image file thus converted does not include the text data. In other words, even if the text data is included in the document file received from the terminal device 200, the server device 400 deletes the text data from the document file, and then converts the document file into the image file. When the conversion into the image file is completed, the server device 400 transmits the image file obtained by the conversion to the terminal device 200.

The terminal device 200 retrieves the text data from the document file having been transmitted to the server 400. For example, in the case in which the document file is a file of the power point format, the file format is substantially the same as XML. Therefore, even in the case in which the terminal device 200 cannot open the document file, it is possible for the terminal device 200 to retrieve the text data from the document file.

When the terminal device 200 receives the image file from the server device 400, the terminal device 200 stores the text data retrieved from the document file in the text chunk in the header area of the image file thus received. Subsequently, due to the operation of the touch panel 232, the terminal device 200 makes the touch panel 232 display the image file, and at the same time transmits the image file to the projector 300 to make the projector 300 project the image on the screen SC. The operation of the terminal device 200 on this occasion is the same as in the first embodiment described above, and therefore, the detained description will be omitted.

### Third Embodiment

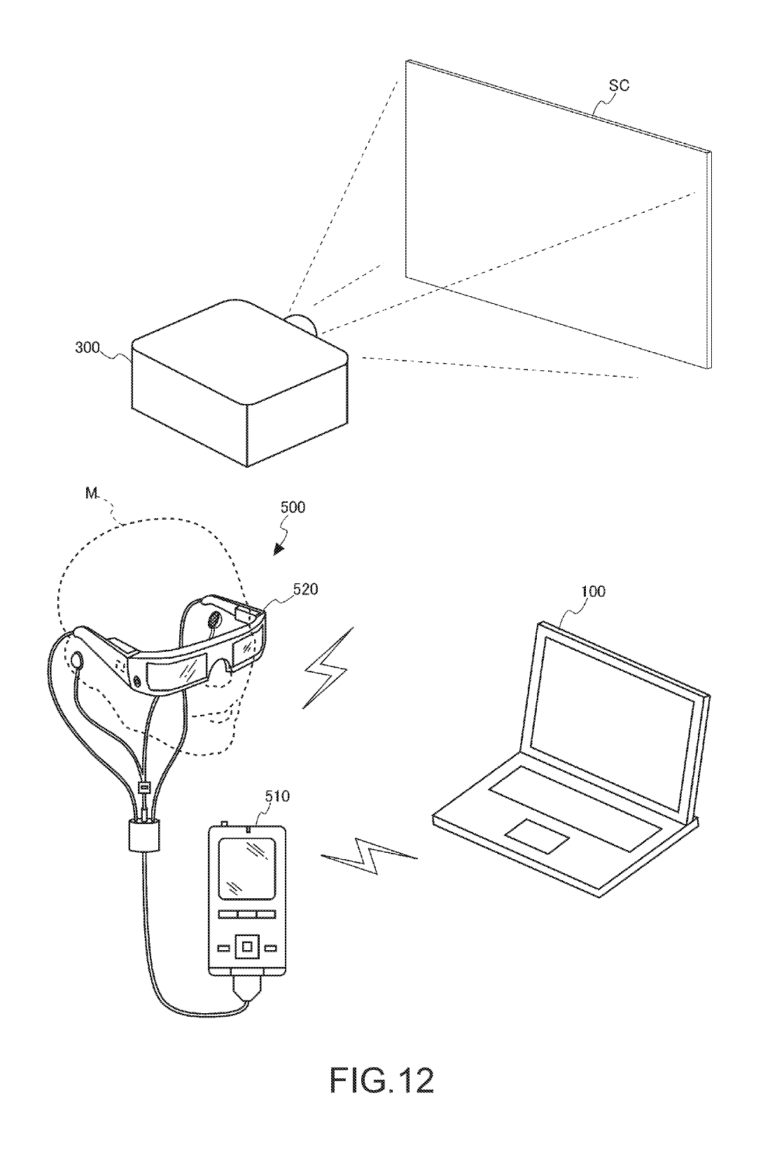

FIG. 12 is a system configuration diagram according to a third embodiment of the invention.

The present embodiment uses a head-mounted display device (hereinafter referred to as a head mounted display (HMD)) 500 instead of the terminal device 200. In the present embodiment, the PC 100 and the HMD 500 are connected to each other with the wireless communication such as wireless LAN or Wi-Fi Direct, or the near-field wireless communication such as Bluetooth or BLE, and the image file is transmitted from the PC 100 to the HMD 500. Further, it is also possible to connect the PC 100 and the HMD 500 with a cable.

The HMD 500 is a display device provided with an image display section 520 mounted on the head of a user M to make the user M visually recognize a virtual image, and a control device 510 for controlling the image display section 520.

The image display section 520 is provided with right and left display units for generating the image light to be visually recognized by the user M, light guide members (not shown) for guiding the image light generated by the display units to the right and left eyes of the user M and so on (not shown). Further, the image display section 520 is a so-called see-through type display device, and has a configuration in which the outside light entering from the front of the user M is transmitted through the right and left light guide member to enter the eyes of the user M. The user M visually recognizes the image light constituting the virtual image and the outside light.

The control device 510 is a control device for transmitting the control signal to the image display section 520 to control the operation of the image display section 520. The control device 510 generates the signal to be transmitted to the right and left display units based on the image data to be displayed by the image display section 520. The signal includes, for example, a vertical sync signal, a horizontal sync signal, a clock signal, and an analog image signal.

Further, it is also possible for the control device 510 to perform a resolution conversion process for converting the resolution of the image data into the resolution suitable for the right and left display units, and an image adjustment process for adjusting the luminance and the chromaticness of the image data.

Further, the control device 510 performs the application to display the app screen 260 similar to FIG. 6 similarly to the terminal device 200. The app screen 260 is the image light generated by the image display section 520, and is a virtual image to be visually recognized by the user M of the HMD 500. Similarly to the first embodiment, in the app screen 260, there are displayed the thumbnail display section 270, the image display section 280, the toolbar 290, and so on, and in the toolbar 290, there are displayed the button 291 for the wireless connection, the button 293 for the image projection, the button 295 for the note display, and so on.

When the operation button (not shown) provided to the control device 510 is operated, and the button 291 for the wireless connection is selected, the control device 510 refers to the connection information 244 to establish the wireless communication with the projector 300.

Further, when the button 293 for the image projection is selected, and one thumbnail is selected from the thumbnails displayed in the thumbnail display section 270, the control section 510 determines the format of the image data corresponding to the thumbnail selected. In the case in which the format of the image data thus selected is not the format which can be processed in the projector 300, the control device 510 converts the format of the image data to generate the image data to be displayed by the projector 300. The control device 510 transmits the image data the format of which has been converted to the projector 300 to display the image data on the screen SC. Further, the HMD 500 displays the image of the image data thus selected in the image display section 280.

Further, when the button 295 for the note display has been selected due to the operation of the operation button, the control device 510 obtains the text data associated with the image data of the image displayed. Then, the control device 510 displays the text based on the text data thus obtained in the image display section 280, in which the image has been displayed up to that moment. The text displayed in the image display section 280 is not projected by the projector 300 on the screen SC, but can visually be recognized only by the user of the terminal device 200.

The embodiment described above is a preferred embodiment of the invention. It should be noted that the invention is not limited to the embodiments, but can be implemented with a variety of modifications within the scope or the spirit of the invention.

For example, in the embodiments described above, there is illustrated the configuration in which the light modulation device 312 is provided with the liquid crystal panels. The liquid crystal panels can be the transmissive liquid crystal panels, but can also be reflective liquid crystal panels. Further, the light modulation device 312 can be provided with a configuration using digital mirror devices (DMD) instead of the liquid crystal panels. Further, it is also possible to adopt a configuration having the digital mirror devices and a color wheel combined with each other. Further, besides the liquid crystal panel or the DMD, the light modulation device 312 adopts configurations capable of modulating the light emitted by the light source.

Further, each of the functional sections of the PC shown in FIG. 9, the terminal device 200 shown in FIG. 5 and the projector 300 shown in FIG. 8 shows a functional configuration, and the specific implementing form thereof is not particularly limited. In other words, it is not necessarily required to install the hardware corresponding individually to each of the functional sections, but it is obviously possible to adopt the configuration of realizing the functions of the plurality of functional sections by a single processor executing a program. Further, a part of the function realized by software in the embodiments described above can also be realized by hardware, and a part of the function realized by hardware can also be realized by software. Besides the above, the specific detailed configuration of each of other sections than the projector can arbitrarily be modified within the scope or the spirit of the invention.

Further, the processing units of the flowchart shown in FIG. 9 and FIG. 10 are obtained by dividing the process of the control section 150 of the PC 100 and the control section 250 of the terminal device 200 in accordance with the principal processing contents in order to make the processes easy to understand. The scope of the invention is not limited by the way of the division or the names of the processing units shown in the flowcharts of FIG. 9 and FIG. 10. Further, the process of the control sections 150, 250 can also be divided into a larger number of processing units, or can also be divided so that one processing unit includes a larger amount of process in accordance with the processing contents. Further, the processing procedures of the flowcharts described above are not limited to the examples shown in the drawings.

Further, the invention can be implemented as a program executed by a computer for realizing the control method of the terminal device 200 described above, a recording medium on which the program is recorded in a computer readable manner, or a transmission medium for transmitting the program. As the recording medium described above, there can be used a magnetic or optical recording device, or a semiconductor memory device. Specifically, there can be cited a portable or rigid recording medium such as a flexible disk, a hard disk drive (HDD), a CD-ROM (compact disc read only memory), a digital versatile disc (DVD), a Blu-ray (registered trademark) disc, a magnetooptic disc, a flash memory, or a card-type recording medium. Further, the recording medium described above can also be a nonvolatile storage device such as the random access memory (RAM), the read only memory (ROM), or the HDD as the internal storage device provided to devices provided to the electronic system 1, or the internal storage device provided to external devices connected to such devices.

What is claimed is:

1. An electronic apparatus comprising:
a communication section adapted to communicate with a display device;
a display section;
an acquisition section adapted to obtain an image file including image data and a header; and
a control section adapted to transmit the image data included in the image file obtained by the acquisition section to the display device using the communication section, retrieve text data from the header of the image file to display the text data on the display section.

2. The electronic apparatus according to claim 1, wherein
in a case in which a format of the image data included in the image file is not a format the display device can process, the control section converts the image data into image data having a format the display device can process, and then transmits the image data to the display device.

3. An electronic system comprising:
a first electronic apparatus having a conversion section adapted to convert a processing target file, which includes page data displayed in a page format, and text data associated with the page data, into the image file including the image data and the header; and
a second electronic apparatus having
an acquisition section adapted to obtain the image file from the first electronic apparatus,
a communication section adapted to communicate with a display device,
a display section, and
a control section adapted to transmit the image data included in the image file obtained by the acquisition section to the display device using the communication section, retrieve text data from the header of the image file to display the text data on the display section.

4. The electronic system according to claim 3, wherein
the conversion section stores the text data in a text chunk formed in the header of the image data.

5. The electronic system according to claim 4, wherein
in a case in which the processing target file includes the page data and an annotation associated with the page data, the conversion section obtains the text data from the annotation to store the text data in the text chunk.

6. The electronic system according to claim 3, wherein
in a case in which a format of the image data included in the image file is not a format the display device can process, the control section converts the image data into image data having a format the display device can process, and then transmits the image data to the display device.

7. The electronic system according to claim 3, wherein
the page data included in the processing target file includes at least either of an image and a text.

8. The electronic system according to claim 3, wherein
the conversion section converts a file in a power point (registered trademark) format as the processing target file into an image file in one of a JPEG format, a GIF format, a PNG format, and a BMP format.

9. A method of controlling an electronic apparatus having a display section and a communication section, the method comprising:
obtaining an image file including image data and a header;
transmitting the image data included in the image file obtained to the display device with the communication section; and
retrieving text data from the header of the image file; and
making the display section display the text data.

10. A computer-readable recording medium storing a program which can be executed by a computer adapted to control an electronic apparatus having a display section and a communication section, the program making the computer execute a process comprising:
obtaining an image file including image data and a header;
transmitting the image data included in the image file obtained to the display device with the communication section;
retrieving text data from the header included in the image file; and
making the display section display the text data.
